(19) United States
(12) Patent Application Publication
(10) Pub. No.: US 2024/0411290 A1
(43) Pub. Date: Dec. 12, 2024

(54) Shower Safety System

(71) Applicants: Matthew Fodera, Hillsborough, NJ (US); Soroush Etemad, Potomac, MD (US); Lucas Janniche, Stevensville, MD (US); William Gleeson, Columbus, OH (US); Muhaimun Islam, Gaithersburg, MD (US); Hogan Mower, Arlington, VA (US)

(72) Inventors: Matthew Fodera, Hillsborough, NJ (US); Soroush Etemad, Potomac, MD (US); Lucas Janniche, Stevensville, MD (US); William Gleeson, Columbus, OH (US); Muhaimun Islam, Gaithersburg, MD (US); Hogan Mower, Arlington, VA (US)

(21) Appl. No.: 18/658,987

(22) Filed: May 8, 2024

Related U.S. Application Data
(60) Provisional application No. 63/500,903, filed on May 8, 2023.

(51) Int. Cl. G05B 19/416; A47K 3/28

(52) U.S. Cl. CPC G05B 19/416; A47K 3/281; G05B 2219/37371

(57) ABSTRACT

The invention relates to a shower safety system designed to enhance safety within bathing areas by monitoring posture for fall detection and responding with immediate safety measures such as water flow shutoff and emergency alert. Other aspects of the invention relate to data security via system communication architecture and computer vision through a distorted medium.

### CROSS-REFERENCE TO RELATED APPLICATIONS

This application claims the benefit of U.S. Provisional Application No. 63/500,903, filed on May 8, 2023, entitled “Shower Safety Device, Systems and Methods Thereof”

### SUMMARY OF THE INVENTION

The subject matter of the present disclosure relates to a shower safety device which provides rapid response to bathroom accidents, aimed at enhancing user safety and preventing fatalities and emotional trauma. Embodiments of the present disclosure can prevent drowning and/or assist incapacitated users in the event of a shower fall. Moreover, embodiments of the device and systems herein can be automated and/or configured for installation by end users. Device and systems described herein can be configured to provide a comprehensive solution for elderly or disabled individuals who may be at risk of falling in the shower. Additionally, for embodiments of the device and systems that are configured to detect falls and alert caregivers or emergency services in real-time, such embodiments can provide peace of mind for family members and ensure the safety of elderly or disabled individuals living at home.

Embodiments of the present disclosure may be integrated into existing healthcare systems and facilities. Accordingly, embodiments described herein can be used to monitor patients in hospitals and nursing homes, reducing the risk of fatalities and ensuring timely assistance when needed.

Embodiments of the present disclosure include an automated shower safety support system designed to detect falls and respond with emergency measures to prevent injury or harm. In order to facilitate fall detection, some embodiments of the system incorporate object detection and image segmentation computer vision models. In one particular embodiment of the present disclosure, the system is equipped with a computer vision fall detection system. The system uses a mini computer to process the images captured by the camera. The camera captures images in real time, and the images are constantly overwritten to protect the user's privacy.

In another aspect in one or more embodiments of the present disclosure, the system is configured to trigger a series of emergency response steps in the event of a fall, including: shutting off the water supply to prevent drowning, and triggering an alert to notify the user's specified emergency contact(s), which may include emergency medical services. In one aspect, the system includes an alert subsystem that can notify different specified phone numbers to ensure timely response in case the primary contact is unavailable. In another aspect, the alert subsystem can be configured with a communication system that is electronically interfaced separately from the computing system to protect sensor data or images. To ensure user privacy, another embodiment of the system can be designed to process all data locally on the device, on a computer that operates independently of the alert subsystem. The alert subsystem can also be configured to work with a variety of communication platforms to integrate apps, devices, and services of the subject system and enable remote monitoring and alert notifications in the event of a fall.

One novel aspect of the embodiments of the present disclosure lies in providing a comprehensive approach to fall detection and response in a specific environment, namely the shower. While other fall detection devices exist, they typically focus on a single function, such as detecting falls through wearable devices or detecting changes in body posture. Systems of the present disclosure go beyond these approaches by providing a real-time monitoring solution specific to the shower environment, with the ability to intervene immediately, before help arrives.

Embodiments of the shower safety device described herein can be designed for easy installation. In one particular embodiment, the shower safety device includes all of its detection, computer, power supply, and fluid shut-off components integrated within and about a single housing. Accordingly, such an embodiment of the device would not require any additional sensors or equipment. One method of installation includes locating the device between the showerhead and the showerhead water supply pipe for data capturing and fall detection above the user and over the shower area. Thus, for one embodiment of the device with the water shut-off component embodied as a solenoid valve, the valve is compatible with standard ½″ showerhead pipe diameters. Locating the device in this reachable location allows for installation by the end user standing in the shower area. Moreover, the device remains within the reach of the user for any programming needs such as, for example, setting emergency contact numbers. However, other embodiments may allow the user to program and/or monitor the device remotely, for example, via a mobile application.

### BRIEF DESCRIPTION OF THE DRAWINGS

FIG. 1 is a perspective view of an embodiment of the shower safety system.

FIG. 2 is a perspective view as in FIG. 1 without the showerhead and water inlet pipe shown.

FIG. 3 is an additional perspective view as in FIG. 2.

FIG. 4 is a side view as in FIG. 2.

FIG. 5 is a front view as in FIG. 2.

FIG. 6 is a perspective view as in FIG. 2 with a system of three buttons shown as an embodiment of a user interface.

FIG. 7 is a front view as in FIG. 1, containing a dotted cut line, A-A, which specifies the location of the section cut in shown in FIG. 8 (A-A).

FIG. 8 (A-A) is a side section view as described in FIG. 7, shown along line A-A of FIG. 7, depicting the inside of an example embodiment of the invention and the direction of water flow through the inlet pipe.

FIG. 9 is a flow diagram depicting an embodiment the hardware interface aspect that strategically separates processing hardware and communication hardware and protects sensor data by making it impossible to access via the communication hardware (by hackers or the like).

FIG. 10 is a perspective view as in FIG. 1 without labels.

### DETAILED DESCRIPTION OF THE INVENTION

The invention disclosed herein pertains to a shower safety system designed to provide enhanced bathroom safety features, including but not limited to pose monitoring, fall detection, water flow interruption, emergency alert capability, or a combination thereof. One embodiment of the invention is depicted by 100, and further by 116. The system aims to respond to accidents and prevent fatalities of individuals, particularly among elderly or disabled individuals who may be at higher risk of falling in the bathroom or shower. Embodiments of the system incorporate various components, including a sensor system, a processing system, and a response system, to achieve these objectives.

The sensor system, which may be depicted by 101, is configured to collect data within the area of a bathing space, such as a shower area, toileting area, or bathroom. This system may include a variety of sensors, such as motion sensors, pressure sensors, infrared sensors, LiDAR sensors, ultrasonic sensors, optical sensors, cameras, infrared cameras, thermal cameras, any other relevant sensors, or a combination thereof. The sensor system may utilize only one sensor, as exemplarily shown by 100. The data collected by the sensor system may include information related to human movement, posture, and activity within the designated area.

The processing system, which may be depicted by 102, can be responsible for analyzing the data collected by the sensor system and deriving conclusions based on this information. The derivation of a conclusion may involve detecting that a human fall, or other safety hazard, has occurred based on data provided by the sensor system. Alternatively, the derivation of a conclusion could simply involve deciding that certain data from the sensor system is noteworthy. This conclusion analysis may involve the use of artificial intelligence, machine learning algorithms, computer vision, or other programmatic tools to identify specific human poses, movements, or falls. The process of deriving a conclusion based on sensor system data can be depicted by 111, wherein the lack of a conclusion could lead to no further steps, and the arrival of a conclusion could trigger response steps to be carried out by the response system, an example of which is depicted by 111-115.

Upon reaching a conclusion, the response system, which can be depicted by 103-104, or also by 115, is activated to implement appropriate measures. These response measures may include activating an alert system or subsystem to notify specified contacts or monitoring systems, which could be represented by 103. In these embodiments, the alert system can be configured to communicate with various platforms and devices to ensure timely notification of caregivers or emergency services. Moreover, this alert system could be connected wirelessly or by wire to a network that is spread throughout a room or multiple rooms or a building or multiple buildings, which would extend its footprint outside of the described bathroom area. An example of this could be represented by the present invention, or a network thereof, configured to operate within a hospital or system of hospitals. To clarify, it should not be assumed that the embodiments represented by the figures restrict any systems of the present invention, in all its embodiments, to be confined within a single housing, as later elaborated upon.

Additionally, the response system may include a water flow control mechanism, such as an electric solenoid valve, as depicted by 104, capable of blocking the flow of water from exiting a showerhead, to prevent drowning or other water-related accidents or inconvenience. In this example, the water flow control mechanism is placed between an existing showerhead 106 and an existing showerhead water inlet pipe 107. Other examples may include a water flow control mechanism that is located on or within a showerhead itself. Other aspects of the response system may include sounding elements such as buzzing or beeping. This beeping could increase in rate to signify a closing time window before more responses may occur.

The system may include an override mechanism to void actions that may be taken by the response system. For example, if the system is configured to detect a shower fall, and a user falls but is able to stand up, an override mechanism may allow the user to cancel any responses, such as a 911 phone call. The override mechanism described may include a user interface equipped with one or more buttons, a screen, a sound system, voice actuation, or a combination thereof, wherein one embodiment of this can be depicted by 117 as a series of buttons.

One embodiment of the system utilizes a computer vision system configured for pose estimation, movement tracking, fall detection, other monitoring types, or a combination thereof, wherein a camera captures real-time images of the shower area and can be depicted by the sensor 101. The images are processed by a computing device within the processing system, which can be depicted by 102. This embodiment may further include privacy protection measures which ensure that images are constantly overwritten to safeguard user privacy. One example of said privacy protection measures could involve a software procedure that is configured to capture and analyze one or more frames, record any conclusions, and immediately overwrite the captured frames. In summary, this embodiment could utilize said computer vision system to activate any relevant response measures as provided in previous examples or in other embodiments that align with the theme of the present invention.

Other embodiments, or other similarly themed safety systems, may include a computer vision system configured for pose estimation, movement tracking, fall detection, other monitoring types, or a combination thereof in which the image data is captured through an “alteration lens”. This lens can more broadly be referred to as a “medium” through which the image data passes before being collected. Embodiments of this medium may include a convex lens, a concave lens, a laser engraved lens, a frosted lens, fog, water, steam, or a combination thereof. The function achieved by this medium, whether intentionally present or unintentionally present, is to “blur” the image data before it is collected. Relating to the shower safety system specifically, an embodiment could involve a camera placed behind a convex lens. The blurring effect achieved by this convex lens could be compared to that of frosted glass. The blurring effect could allow this camera to collect image data of an individual whose private bodily details, such as facial and genital features, are unrecognizable due to the lens, which would reduce the invasiveness of a bathroom computer vision system. While this example is applied to the shower safety system invention, any computer vision system capable of performing the monitoring types described herein, on image data that has been manipulated in the ways described herein, could be considered an embodiment of this aspect of the invention.

Other embodiments, or various safety systems which perhaps have different aims or functions, may embody a system architecture in the same secure theme, which may be represented or summarized by 108, that incorporates features herein to enhance security and prevent hacking or unauthorized access to sensitive data 109. Communication of an event, such as a human fall, in such embodiments can be facilitated by communication hardware 115, which receives one or more trigger signal indicating conclusions reached by the processing system 110. Importantly, the communication hardware could be physically incapable of accessing the sensor system data, writing information to the processing hardware, requesting data from the processing hardware, or a combination thereof. An example of this could be achieved by interfacing the processing hardware and communication hardware via a single “trigger” wire 114, in addition to a common electrical ground connection. In this example, the communication hardware could be capable of wirelessly communicating with relevant parties, and the processing hardware could be deprived of wireless communication capabilities. Furthermore, the “trigger” wire could be connected to an output pin on the processing hardware and to an input pin on the communication hardware, acting as a binary “YES/NO” switch 112-113. Upon conclusion that a certain event has occurred 111, the processing hardware could be configured to send said binary signal via the “trigger” wire, and the communication hardware could carry out an appropriate response measure, for example, notifying appropriate individuals of said event. Relating to data security, if the system were to experience wireless hacking via the communication hardware, the sensor data 109 would be inaccessible by said hacker. This would ensure the security and integrity of the system, as well as prevent unauthorized access to sensitive sensor data.

The system described herein could be electronically powered in several ways. One method of powering involves a wired alternating current (AC) connection. This AC connection would likely require some transformer or electronic device to convert the current to its appropriate form for interaction with system components. Other methods of powering may involve a system battery, composed of one or more battery cells, which would supply a direct current (DC). The battery could utilize a detachable charging for charging. The battery could also be detachable itself, to be charged elsewhere while leaving the rest of the system in place. The battery could also be charged by a water turbine, spun by the water flow from the shower. The battery could also be charged via a photoelectric mechanism, like a solar panel.

Installation of the system is designed to be user-friendly, with embodiments available for retrofitting into existing shower setups, as depicted by 100. In this type of embodiment, the present invention could be designed to be installed in between an existing showerhead and its water feed pipe, via some connection. This connection could involve threading into standard piping sizes, wherein the present invention screws onto or into an existing water feed pipe 107, and an existing showerhead screws onto or into the present invention. The water flow control mechanism, such as the solenoid valve, could be compatible with such standard shower pipe diameters for easy integration into existing plumbing systems. The systems described herein could be contained within a housing, in which said housing may resemble 105, may resemble a showerhead like 106, or may house components in some other method or variation. The system housing may contain all necessary components, including but not limited to sensors, computing hardware, and power supplies, making installation straightforward for end-users. Alternatively, embodiments of the system may include components that are spread throughout a room, facility, or network and are not necessarily contained within a single housing.

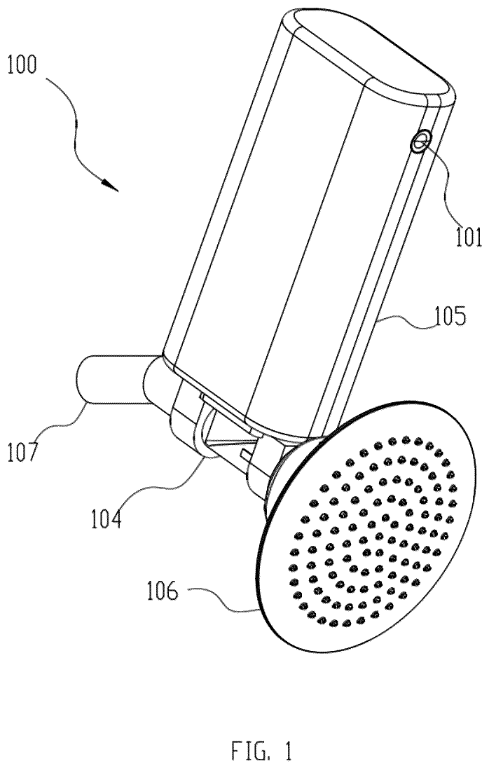

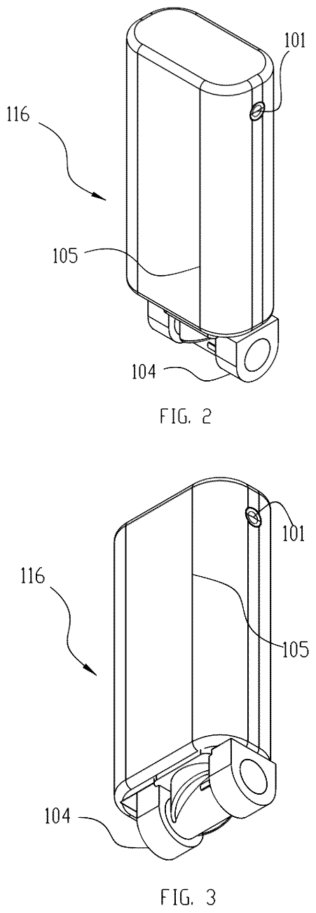

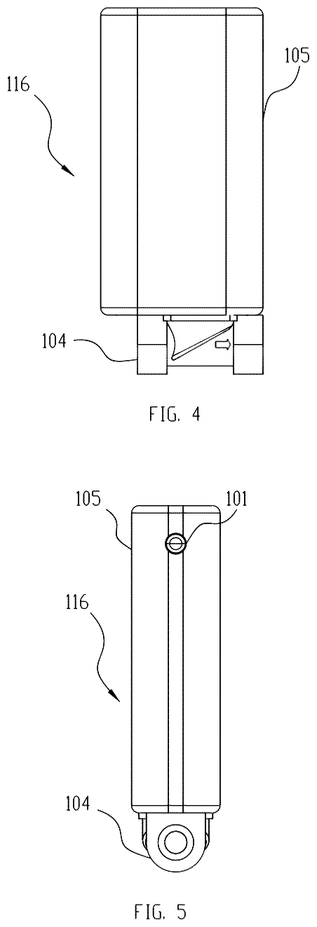

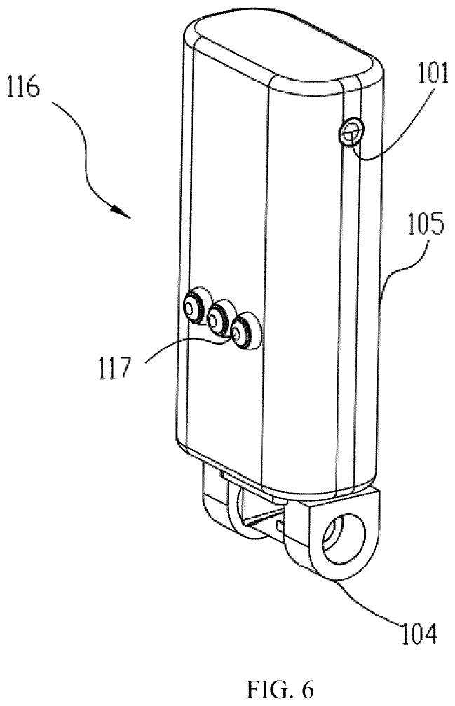

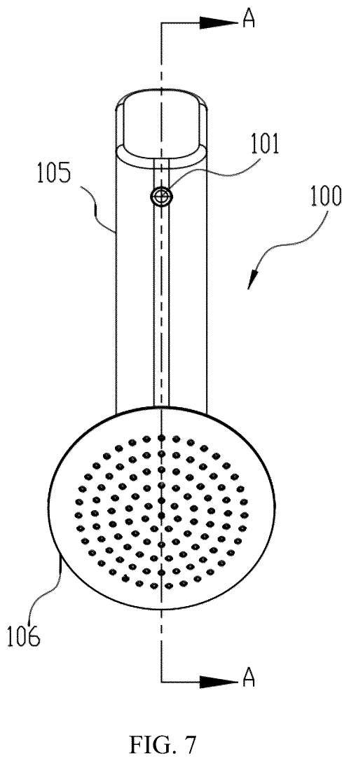

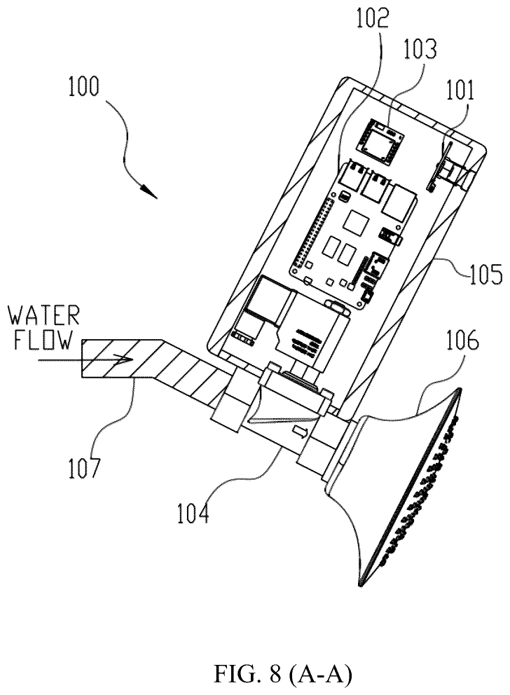

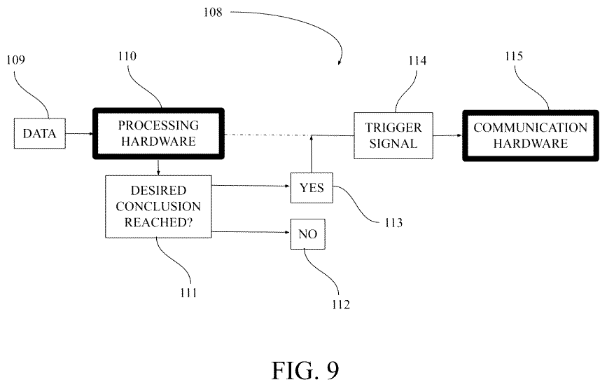

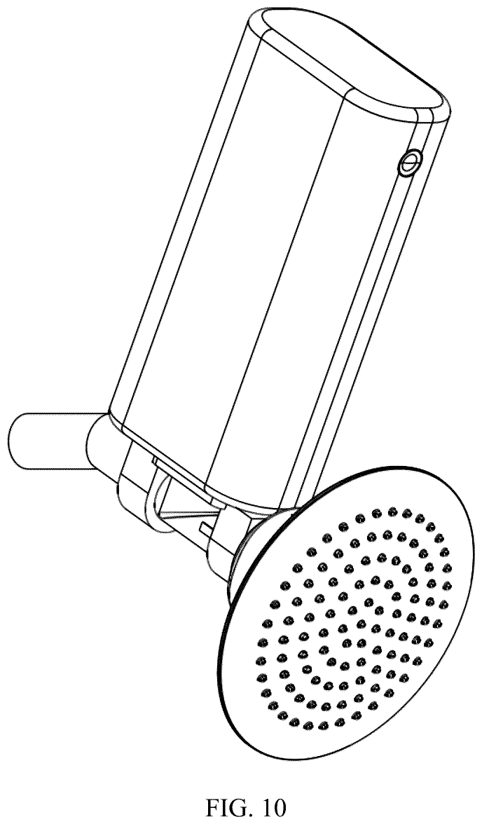

The invention described herein could be configured for a shower environment specifically, as depicted in several of the figures (for example, FIG. 1). However, it should be noted that aspects of the invention could be embodied by a general safety system, whether configured for a shower environment, a bathroom environment, a home environment, a commercial environment, or elsewhere.

Overall, the shower safety system described herein provides a comprehensive solution for ensuring a timely response to bathroom accidents, particularly in environments where the risk of falling is high. The invention can provide peace of mind to caregivers and family members while enhancing user safety and independence. It should be noted that any aspect described herein could be modified to achieve the same or similar utility or function within the theme of the present invention.

### SCOPE OF THE INVENTION

While various embodiments of the present disclosure are described herein, it should be understood that they have been presented by way of example only, and not limitation. It will be apparent to persons skilled in the relevant art that various changes in form and detail can be made therein without departing from the spirit and scope of the present disclosure or the claims included herein. Thus, the breadth and scope of the present disclosure should not be limited by any of the exemplary embodiments provided herein.

What is claimed is:

1. A shower safety system comprising:
a sensor system configured to collect data in an area, in which said area consists of a bathing area, toileting area, washroom area, bathroom area, or a combination thereof,
a processing system programmed to process data from said sensor system, in which said processing system is capable of deriving a conclusion or deriving multiple conclusions based on said data, of which said conclusion or said conclusions includes human pose estimation, determination of human posture, determination of human movement, detection of a specific human pose, detection of multiple specific human poses, detection of a human fall, or a combination thereof,
a response system, of which said response system is separate from, connected to, or embedded within said processing system, in which said response system is configured to activate a response measure or activate multiple response measures upon said conclusion or upon said conclusions;
or a combination thereof.

2. A shower safety system as in claim 1, wherein said sensor system includes a motion sensor, pressure sensor, infrared sensor, LiDAR sensor, ultrasonic sensor, radar sensor, proximity sensor, image sensor, light sensor, hall effect sensor, accelerometer, optical sensor, camera, infrared camera, thermal camera, or a combination thereof.

3. A shower safety system as in claim 1, wherein said processing system utilizes artificial intelligence, at least one machine learning algorithm, or a combination thereof to derive said conclusion or derive said conclusions.

4. A shower safety system as in claim 1, wherein said processing system is equipped with computer vision capability to derive said conclusion or derive said conclusions.

5. A shower safety system as in claim 1, wherein said response measure or said response measures involves recording data from said sensor system, recording said conclusion from said processing system, recording said conclusions from said processing system, or a combination thereof.

6. A shower safety system as in claim 1, wherein said response system comprises an alert system, of which said alert system is separate from, connected to, or embedded within said response system, in which said alert system is configured upon said conclusion or upon said conclusions to notify a specified contact, notify multiple specified contacts, notify a home monitoring system, notify a commercial monitoring system, notify a home security system, notify a commercial security system, or a combination thereof.

7. A shower safety system as in claim 1, wherein said response system comprises a water flow control mechanism, in which said water flow control mechanism is configured to shut off water flow within said area.

8. A shower safety system as in claim 1, in which said shower safety system is electronically powered by an alternating current.

9. A shower safety system as in claim 1, in which said shower safety system is electronically powered by at least one direct current battery, in which said battery is rechargeable via a detachable alternating current connection, a water turbine, or a combination thereof.

10. A direct current battery as in claim 9, wherein said battery is detachable from said shower safety system.

11. At least one system as claim 1, in which said system or systems is contained within a housing, attached to a housing, or a combination thereof, in which said housing acts as a showerhead.

12. A housing as in claim 11, in which said housing is able to be retrofitted for use with an existing showerhead, shower pipe, water pipe, waterspout, or a combination thereof.

13. At least one system as in claim 1, in which said system or systems is located throughout a building, multiple buildings, a wireless network, multiple wireless networks, said area, or a combination thereof.

14. A system architecture comprising:
processing hardware configured for processing data, wherein said processing hardware is capable of deriving at least one conclusion from said data;
communication hardware interfacing electronically with said processing hardware, wherein said interface enables said communication hardware to receive knowledge of said conclusion via at least one trigger signal;
wherein said interface physically renders said communication hardware incapable through programmatic means of reading said data, writing data to said processing hardware, requesting data from said processing hardware, or a combination thereof.

15. A system architecture as in claim 14, wherein said processing hardware and said communication hardware are configured for wireless communication, are not configured for wireless communication, or a combination thereof.

16. A system comprising:
a sensor system configured to collect image data, in which said image data is collected through a medium, in which said medium renders said image data blurred, hazed, clouded, obstructed, partially obstructed, or a combination thereof;
a computer vision system configured to process said image data;
or a combination of said sensor system and said computer vision system.

17. A system as in claim 16, in which said medium reduces the recognizability of an individual's human identity, an individual's facial features, an individual's bodily features, an individual's genitalia, or a combination thereof.

18. A system as in claim 16, in which said medium achieves said rendering via a convex lens, a concave lens, a laser engraved lens, a frosted lens, or a combination thereof.
